(19) United States
(12) Patent Application Publication
(10) Pub. No.: US 2026/0367999 A1
(43) Pub. Date: Nov. 19, 2026

(54) OPTIMAL STOPPING TASK OFFLOADING OPTIMIZATION SYSTEM AND METHOD IN ENERGY-LIMITED ENVIRONMENTS

(71) Applicant: NANJING UNIVERSITY OF POSTS AND TELECOMMUNICATIONS, Nanjing (CN)

(72) Inventors: Tingting LIU, Nanjing (CN); Jiali CHEN, Nanjing (CN); Jia XU, Nanjing (CN); Wei CHEN, Nanjing (CN); Le YU, Nanjing (CN); Lingyun JIANG, Nanjing (CN); Weifeng LU, Nanjing (CN); Fu XIAO, Nanjing (CN)

(73) Assignee: NANJING UNIVERSITY OF POSTS AND TELECOMMUNICATIONS, Nanjing (CN)

(21) Appl. No.: 19/710,446

(22) Filed: Jun. 17, 2026

Related U.S. Application Data
(63) Continuation of application No. PCT/CN2025/111437, filed on Jul. 30, 2025.

(30) Foreign Application Priority Data
May 13, 2025 (CN) 202510607734.4

(51) Int. Cl. G06F 9/50

(52) U.S. Cl. CPC G06F 9/5094; G06F 2209/508; G06F 2209/509

(57) ABSTRACT

An optimal stopping task offloading optimization system and method in energy-limited environments are provided. By calculating the maximum allowable observation count based on energy consumption constraints and applying optimal stopping theory, efficient task offloading is achieved, which is suitable for energy-limited vehicular network scenarios. The method includes: constructing a vehicular network task offloading model based on optimal stopping theory, establishing an objective function to minimize the expected total offloading cost according to RSU load and observation cost; introducing energy consumption constraints by constructing an energy consumption inequality; calculating the maximum allowable observation count through the energy consumption constraints, and solving based on optimal stopping theory to obtain a series of comparison thresholds; comparing the observed current RSU load with the calculated comparison thresholds to identify a locally optimal RSU that satisfies the conditions for offloading.

### CROSS REFERENCE TO THE RELATED APPLICATIONS

This application is a continuation application of International Application No. PCT/CN2025/111437, filed on Jul. 30, 2025, which is based upon and claims priority to Chinese Patent Application No. 202510607734.4, filed on May 13, 2025, the entire contents of which are incorporated herein by reference.

### TECHNICAL FIELD

The present invention relates to the field of vehicular network technology, particularly to an optimal stopping task offloading optimization system and method in energy-limited environments, used to optimize task offloading decisions for vehicles under energy consumption constraints.

### BACKGROUND

Computational task offloading strategies in vehicular networks are a popular research direction. Due to limited computational capabilities, vehicles often need to offload computation-intensive tasks to roadside units (RSUs). RSU servers have a load value; if the RSU load is high, it affects task computation time, so vehicles aim to find an RSU with a lower load, requiring observation of RSU loads before offloading. In practical scenarios, vehicles have limited energy, and frequent observation of RSUs may lead to energy depletion, affecting system sustainability. To help vehicles select an RSU with as low a load as possible for task offloading while satisfying energy consumption constraints, it is necessary to propose a task offloading method based on optimal stopping theory under energy consumption constraints, balancing load distribution and energy efficiency.

This application differs from the aforementioned reference document in the following aspects:

Technical comparison with Patent CN119356754A “A Vehicular Network Task Offloading Method Based on Optimal Stopping Theory”

### I. Model Elements and Constraints

In Patent CN119356754A, only vehicle speed and RSU load are used as cost data to establish an objective function minimizing the expected total offloading cost, and a single reference value is obtained through optimal stopping theory to determine the offloading timing.

The present invention introduces additional energy consumption constraints on top of the aforementioned cost model, calculates the maximum allowable observation count in an energy-limited environment by constructing an energy consumption inequality, ensuring that offloading decisions are both cost-optimal and satisfy the energy consumption limit.

### II. Threshold Calculation and Decision Mechanism

Patent CN119356754A calculates only one reference value, comparing the observed current RSU load with this reference value to determine the optimal stopping time and perform offloading.

The present invention, based on optimal stopping theory, solves for a series of increasing comparison thresholds for the maximum allowable observation count; after each observation of the current RSU load, it is compared with the corresponding threshold to dynamically select the first locally optimal RSU that satisfies the conditions for offloading, achieving finer optimization in energy consumption and decision precision.

### SUMMARY

The main objective of the present invention is to overcome the shortcomings and deficiencies of the prior art. The present invention constructs a two-stage detection model, calculates the maximum observation count by introducing energy consumption constraints, combines optimal stopping theory for dynamic offloading timing decisions, and achieves load balancing for task computation in vehicular networks through optimized computational task offloading, improving the utilization of computational resources.

To achieve the above inventive objective, the present invention proposes an optimal stopping task offloading optimization method in an energy-limited environment, characterized by including the following steps:
S1: constructing a vehicular network task offloading model based on optimal stopping theory, establishing an objective function to minimize the expected total offloading cost according to RSU load and observation cost; introducing energy consumption constraints by constructing an energy consumption inequality;
S2: calculating the maximum allowable observation count through the energy consumption constraints, and solving based on optimal stopping theory to obtain a series of comparison thresholds;
S3: comparing the observed current RSU load with the calculated comparison thresholds to identify a locally optimal RSU that satisfies the conditions for offloading.

As a further improvement of the present invention, S1: constructing a vehicular network task offloading model based on optimal stopping theory, establishing an objective function to minimize the expected total offloading cost according to RSU load and observation cost; introducing energy consumption constraints by constructing an energy consumption inequality, wherein the energy consumption required for vehicle i throughout the process is calculated as:

$${E}_{i}^{obs} = ( μ \cdot {v}_{i}^{2} + φ ) \cdot \frac{Δ L}{{v}_{i}} = ( μ \cdot {v}_{i} + \frac{φ}{{v}_{i}} ) \cdot Δ L , n \cdot {E}_{i}^{obs} + {E}_{i}^{off} \leq {E}_{i}^{th}$$

where μ denotes an energy consumption coefficient proportional to the square of the moving speed, such as an air resistance coefficient; φ denotes a fixed energy consumption coefficient independent of the vehicle's traveling speed, such as a rolling resistance coefficient; vᵢ is the traveling speed of vehicle i; ΔL denotes the distance between adjacent RSUs; n is the number of the selected RSU;

$${E}_{i}^{obs}$$

denotes the energy consumption required for vehicle i to observe one RSU,

$${E}_{i}^{off}$$

is the energy consumption required for vehicle i to offload the task, and

$${E}_{i}^{th}$$

is the available energy budget for vehicle i.

As a further improvement of the present invention, S1: establishing the objective function to minimize the expected total offloading cost includes:
establishing the objective function for vehicle offloading, with the optimization problem expressed as:

$${min}_{n} E [ {I}_{i}^{n} ] = {min}_{n} E [ min \{ {y}_{i}^{n} , E [ {I}_{i}^{n + 1} ] \} ]$$

$$s . t . C 1 : n \cdot {E}_{i}^{obs} + {E}_{i}^{off} \leq {E}_{i}^{th}$$

$$C 2 : n ∈ [ 1 , N ]$$

where n is the number of the selected RSU, N is the total known number of RSUs,

$${I}_{i}^{n}$$

denotes the cost incurred when vehicle i decides at the current moment whether to offload the task to RSU n, taking the smaller value between the current offloading cost

$${y}_{i}^{n}$$

and the expected offloading cost

$$E [ {I}_{i}^{n + 1} ] , where {y}_{i}^{n}$$

is the offloading cost if stopping observation and selecting the current RSU at this moment, and

$$E [ {I}_{i}^{n + 1} ]$$

is the expected cost of continuing to observe subsequent RSUs;

$${E}_{i}^{obs}$$

denotes the energy consumption required for vehicle i to observe one RSU,

$${E}_{i}^{off}$$

is the energy consumption required for vehicle i to offload the task, and

$${E}_{i}^{th}$$

is the available energy budget for vehicle i.

As a further improvement of the present invention, the total offloading cost for vehicle i deciding to offload at its n^{th} observation moment is:

$${y}_{i}^{n} = {x}_{n} + \frac{Δ L \cdot n}{{v}_{i}} \cdot c$$

where xₙ denotes the load of RSUn, i.e., the total delay incurred when the task is offloaded to the selected RSU for processing; ΔL denotes the distance between adjacent RSUs, n is the number of the current RSU, vᵢ is the traveling speed of vehicle i, and c denotes the observation cost for observing one RSU.

As a further improvement of the present invention, S3: comparing the observed current RSU load with the calculated comparison thresholds to identify a locally optimal RSU that satisfies the conditions for offloading; if vehicle i observes until the end without offloading, it must offload to the last RSU, and the optimal offloading cost at the N^{th} observation is:

$${I}_{i}^{N} = {y}_{i}^{N}$$

where,

$${y}_{i}^{N}$$

is the offloading cost for offloading to the last RSU, i.e., the N^{th} RSU.

The present invention proposes a system using the optimal stopping task offloading optimization method in an energy-limited environment, which includes:
a model construction module, configured to construct a vehicular network task offloading model with energy consumption constraints, establish an objective function to minimize the expected total offloading cost according to parameters such as vehicle speed, remaining energy, and RSU coverage range, and calculate the energy consumption for a single observation; the objective function parameters include RSU load delay, observation count, and observation cost;
a threshold calculation module, configured to calculate the maximum allowable observation count through the energy consumption constraint inequality, and solve for comparison thresholds at each observation stage using the backward induction method based on optimal stopping theory;
an offloading execution module, configured to acquire the current RSU load status and vehicle energy status in real time, compare the current load with the corresponding stage threshold, execute task offloading when the offloading condition is satisfied, otherwise continue observation until forced offloading at the last RSU.

### Beneficial Effects

The present invention constructs a vehicular network task offloading model with energy consumption constraints, establishes an objective function to minimize the expected total offloading cost according to parameters such as vehicle speed, remaining energy, and RSU coverage range; the objective function parameters include RSU load delay and observation cost. By constraining the maximum allowable observation count, it prevents vehicles from consuming excessive energy during task offloading, conserving system energy. Optimal stopping theory is utilized to find locally optimal RSUs for task offloading, comparing the observed current RSU load with a calculated comparison threshold to select low-load RSUs, optimizing resource utilization.

By referring to the following drawings and detailed description of specific embodiments of the present invention, the features and advantages of the present invention will become clear.

### BRIEF DESCRIPTION OF THE DRAWINGS

FIG. 1 is a flowchart of the vehicular network task offloading method based on optimal stopping theory and energy consumption constraints;

FIG. 2 is a schematic diagram of the vehicular network task offloading system based on optimal stopping theory and energy consumption constraints;

FIG. 3 is a cost comparison graph of the proposed algorithm under different energy consumption constraints;

FIG. 4 is a cost comparison graph between the proposed algorithm and other algorithms.

### DETAILED DESCRIPTION OF THE EMBODIMENTS

The technical solutions in the embodiments of the present invention will be clearly and completely described below in conjunction with the accompanying drawings. It is apparent that the described embodiments are only a part of the embodiments of the present invention, and not all of them. Based on the embodiments of the present invention, all other embodiments obtained by ordinary technicians in the field without creative effort shall fall within the scope of protection of the present invention.

### Embodiment 1

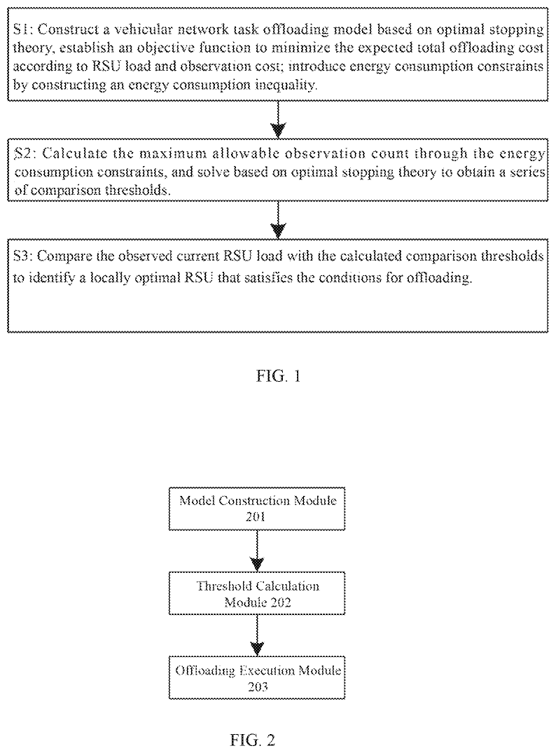

FIG. 1 is a flowchart of the optimized task offloading method for computational tasks in vehicular networks based on optimal stopping theory. As shown in FIG. 1, this embodiment provides an optimal stopping task offloading optimization system and method in an energy-limited environment, the method including the following steps:

To find the optimal RSU for task offloading, optimal stopping theory is utilized to solve this problem by comparing the observed current RSU load with a threshold to determine the optimal offloading timing, achieving load balancing among RSUs in vehicular networks and improving task offloading efficiency.
S1: constructing a vehicular network task offloading model based on optimal stopping theory, establishing an objective function to minimize the expected total offloading cost according to RSU load and observation cost; introducing energy consumption constraints by constructing an energy consumption inequality;
S2: calculating the maximum allowable observation count through the energy consumption constraints, and solving based on optimal stopping theory to obtain a series of comparison thresholds;
S3: performing real-time observation of RSUs, comparing the observed current RSU load with the calculated comparison thresholds to identify a locally optimal RSU that satisfies the conditions for offloading.

The method of this embodiment optimizes the offloading of computational tasks, achieves load balancing for task computation in vehicular networks, and improves the utilization of computational resources.

In step S1, establishing the objective function to minimize the expected offloading cost includes:

establishing the objective function for vehicle offloading, with the optimization problem expressed as:

$${min}_{n} E [ {I}_{i}^{n} ] = {min}_{n} E [ min \{ {y}_{i}^{n} , E [ {I}_{i}^{n + 1} ] \} ]$$

$$s . t . C 1 : n \cdot {E}_{i}^{obs} + {E}_{i}^{off} \leq {E}_{i}^{th}$$

$$C 2 : n ∈ [ 1 , N ]$$

where n is the number of the selected RSU, N is the total known number of RSUs,

$${I}_{i}^{n}$$

denotes the cost incurred when vehicle i decides at the current moment whether to offload the task to RSU n, taking the smaller value between the current offloading cost

$${y}_{i}^{n}$$

and the expected offloading cost

$$E [ {I}_{i}^{n + 1} ] , where {y}_{i}^{n}$$

is the offloading cost if stopping observation and selecting the current RSU at this moment, and

$$E [ {I}_{i}^{n + 1} ]$$

is the expected cost of continuing to observe subsequent RSUs;

$${E}_{i}^{obs}$$

denotes the energy consumption required for vehicle i to observe one RSU,

$${E}_{i}^{off}$$

is the energy consumption required for vehicle i to offload the task, and

$${E}_{i}^{th}$$

is the available energy budget for vehicle i.

Preferably, the total offloading cost for vehicle i deciding to offload at its n^{th} observation moment is:

$${y}_{i}^{n} = {x}_{n} + \frac{Δ L \cdot n}{{v}_{i}} \cdot c$$

where xₙ denotes the load of RSU n, i.e., the total delay incurred when the task is offloaded to the selected RSU for processing; ΔL denotes the distance between adjacent RSUs, n is the number of the current RSU, vᵢ is the traveling speed of vehicle i, and c denotes the observation cost for observing one RSU.

Preferably, if vehicle i observes until the end without offloading, it must offload to the last RSU, and the optimal offloading cost at the N^{th} observation is:

$${I}_{i}^{N} = {y}_{i}^{N}$$

where

$${y}_{i}^{N}$$

is the offloading cost for offloading to the N^{th} RSU.

Preferably, the energy consumption required for vehicle i throughout the process is calculated as:

$${E}_{i}^{obs} = ( μ \cdot {v}_{i}^{2} + φ ) \cdot \frac{Δ L}{{v}_{i}} = ( μ \cdot {v}_{i} + \frac{φ}{{v}_{i}} ) \cdot Δ L , n \cdot {E}_{i}^{obs} + {E}_{i}^{off} \leq {E}_{i}^{th}$$

where μ denotes an energy consumption coefficient proportional to the square of the moving speed, such as an air resistance coefficient; φ denotes a fixed energy consumption coefficient independent of the vehicle's traveling speed, such as a rolling resistance coefficient; vᵢ is the traveling speed of vehicle i; ΔL denotes the distance between adjacent RSUs; n is the number of the selected RSU;

$${E}_{i}^{obs}$$

denotes the energy consumption required for vehicle i to observe one RSU,

$${E}_{i}^{off}$$

is the energy consumption required for vehicle i to offload the task, and Eth is the available energy budget for vehicle i.

In step S2, the maximum allowable observation count

$${N}_{i}^{max}$$

is calculated through the energy consumption constraints, and the comparison thresholds

$${ξ}_{i}^{n}$$

are solved based on optimal stopping theory. The specific process is as follows:

In step S2, under the satisfaction of energy consumption constraints, the maximum allowable observation count for vehicle i can be calculated as:

$${N}_{i}^{max} = ⌊ \frac{{E}_{i}^{th} - {E}_{i}^{off}}{{E}_{i}^{obs}} ⌋$$

where

$${E}_{i}^{obs}$$

denotes the energy consumption required for vehicle i to observe one RSU,

$${E}_{i}^{off}$$

is the energy consumption required for vehicle i to offload the task, and Eᵢ^{th} is the available energy budget for vehicle i.

Since there are a total of N RSUs along the roadside during observation, the actual maximum allowable observation count of RSUs for vehicle i is the smaller value between the total known number N of RSUs and the maximum allowable observation count satisfying the energy consumption constraints

$${N}_{i}^{max} ,$$

i.e.:

$${N}_{i} = min \{ {N}_{i}^{max} , N \}$$

In step S2, to select the optimal value as much as possible, the vehicle should offload when the current offloading cost is lower than the expected future offloading cost:

$${y}_{i}^{n} = {x}_{n} + \frac{Δ L \cdot n}{{v}_{i}} \cdot c \leq E [ {I}_{i}^{n + 1} ]$$

where

$${y}_{i}^{n}$$

denotes the total offloading cost for vehicle i, xₙ denotes the load of RSU n, i.e., the total delay incurred when the task is offloaded to the selected RSU for processing; ΔL denotes the distance between adjacent RSUs, n is the number of the current RSU, vᵢ is the traveling speed of vehicle i, c denotes the observation cost for observing one RSU, and

$${I}_{i}^{n + 1}$$

denotes the cost incurred when vehicle i decides at the current moment whether to offload the task to RSU n+1.

Rearranging the above equation, the condition that xₙ must satisfy is as follows:

$${x}_{n} \leq E [ {I}_{i}^{n + 1} ] - \frac{Δ L \cdot n}{{v}_{i}} \cdot c$$

For simplicity and convenience in subsequent steps, an auxiliary variable

$${ζ}_{i}^{n}$$

is introduced here:

$${ξ}_{i}^{n} = E [ {I}_{i}^{n + 1} ] - \frac{Δ L \cdot n}{{v}_{i}} \cdot c$$

Now, it is only necessary to compare xₙ with

$${ξ}_{i}^{n} .$$

### Substituting

$${I}_{i}^{n} = min \{ {y}_{i}^{n} , E [ {I}_{i}^{n + 1} ] \}$$

to calculate

$${ξ}_{i}^{n} .$$

$$\begin{matrix}{ξ}_{i}^{n} & = E [ min ( {y}_{i}^{n + 1} , E [ {I}_{i}^{n + 2} ] ) ] - \frac{Δ L \cdot n}{{v}_{i}} \cdot c \\ & = E [ min ( {x}_{n + 1} + \frac{Δ L \cdot ( n + 1 )}{{v}_{i}} \cdot c , {ξ}_{i}^{n + 1} + \frac{Δ L \cdot ( n + 1 )}{{v}_{i}} \cdot c ) ] - \frac{Δ L \cdot n}{{v}_{i}} \cdot c \\ & = E [ min ( {x}_{n + 1} , {ξ}_{i}^{n + 1} ) ] - \frac{Δ L}{{v}_{i}} \cdot c\end{matrix}$$

where,

$${y}_{i}^{n + 1}$$

is the offloading cost if stopping observation and selecting the current RSU at this moment, and

$$E [ {I}_{i}^{n + 2} ]$$

is the expected cost of continuing to observe subsequent RSUs.

Here, the random sequence xₙ is converted into a continuous variable x:

$$\begin{matrix}{ξ}_{i}^{n} & = E [ min ( {x}_{n + 1} , {ξ}_{i}^{n + 1} ) ] + \frac{Δ L}{{v}_{i}} \cdot c \\ & = {\int }_{0}^{∞} min ( x , {ξ}_{i}^{n + 1} ) f ( x ) dx + \frac{Δ L}{{v}_{i}} \cdot c \\ & = {\int }_{0}^{{ξ}_{i}^{n + 1}} xf ( x ) dx + {\int }_{{ξ}_{i}^{n + 1}}^{∞} {ξ}_{i}^{n + 1} f ( x ) dx + \frac{Δ L}{{v}_{i}} \cdot c \\ & = {\int }_{0}^{{ξ}_{i}^{n + 1}} xf ( x ) dx + {ξ}_{i}^{n + 1} [ 1 - F ( {ξ}_{i}^{n + 1} ) ] + \frac{Δ L}{{v}_{i}} \cdot c\end{matrix}$$

where f(x) denotes the probability density function of variable x, and F(x) denotes the cumulative distribution function of variable x.

In step S3, the reference threshold

$${ξ}_{i}^{n}$$

is calculated through the above process and compared with the RSU load currently observed by the vehicle. If the

$${x}_{n} < {ξ}_{i}^{n} ,$$

the optimal strategy is to stop observation and offload the task to the current RSU; if

$${x}_{n} \geq {ξ}_{i}^{n} ,$$

it is best to continue observing subsequent RSUs.

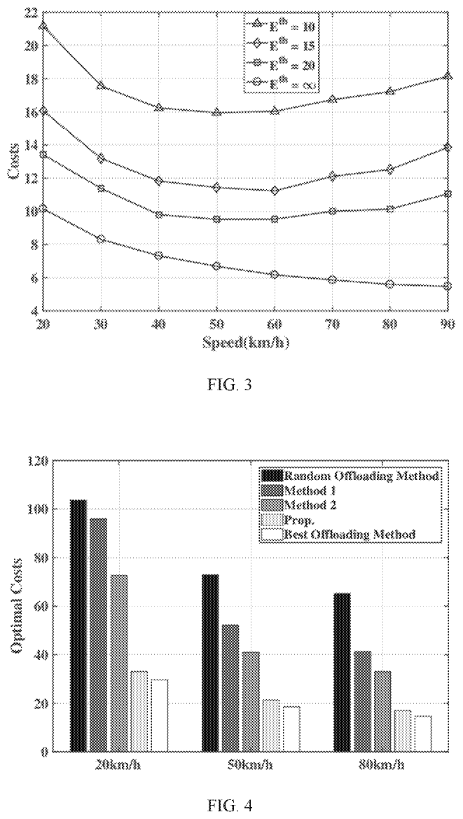

FIG. 3 shows the cost variation with moving speed for the proposed algorithm under different energy constraints. It can be observed from the graph that as the moving speed increases, the cost curve first decreases and then increases. This indicates that there exists an optimal moving speed that minimizes the cost. Additionally, it is noteworthy that the cost curve under stricter energy constraints is always higher than that under looser energy constraints or without constraints. This indicates that imposing stricter energy constraints leads to higher costs.

FIG. 4 compares the costs among the proposed offloading method, random offloading method, optimal offloading method, and two observe-first-then-offload methods (Method 1 and Method 2). Methods 1 and 2 optimize the observation count to maximize the probability of selecting the optimal solution, or the optimal or suboptimal solution, respectively. It can be seen that as the traveling speed increases, the cost of each method decreases. Compared to other offloading methods, the method proposed in this embodiment achieves lower costs. The algorithm proposed in this text can achieve costs close to those of the optimal algorithm.

This embodiment constructs a vehicular network task offloading model based on optimal stopping theory, establishes an objective function to minimize the expected total offloading cost according to RSU load and observation cost, introduces energy consumption constraints by constructing an energy consumption inequality, calculates the maximum allowable observation count through the energy consumption constraints, solves based on optimal stopping theory to obtain a series of comparison thresholds, and during observation, compares the observed current RSU load with the calculated comparison thresholds to identify a locally optimal RSU that satisfies the conditions for offloading. This achieves load balancing among RSUs in vehicular networks and improves resource utilization.

### Embodiment 2

FIG. 2 is a schematic diagram of the optimal stopping task offloading optimization system in an energy-limited environment. As shown in FIG. 2, this embodiment provides an optimal stopping task offloading optimization system in an energy-limited environment, the system including:
a model construction module 201, configured to construct a vehicular network task offloading model with energy consumption constraints, establish an objective function to minimize the expected total offloading cost according to parameters such as vehicle speed, remaining energy, and RSU coverage range, and calculate the energy consumption for a single observation; the objective function parameters include RSU load delay, observation count, and observation cost;
a threshold calculation module 202, configured to calculate the maximum allowable observation count through the energy consumption constraint inequality, and solve for comparison thresholds at each observation stage using the backward induction method based on optimal stopping theory;
an offloading execution module 203, configured to acquire the current RSU load status and vehicle energy status in real time, compare the current load with the corresponding stage threshold, execute task offloading when the offloading condition is satisfied, otherwise continue observation until forced offloading at the last RSU.

Preferably, establishing the objective function to minimize the expected total offloading cost in the construction module includes:
establishing the objective function for vehicle offloading, with the optimization problem expressed as:

$${min}_{n} E [ {I}_{i}^{n} ] = {min}_{n} E [ min \{ {y}_{i}^{n} , E [ {I}_{i}^{n + 1} ] \} ]$$

$$s . t . C 1 : n \cdot {E}_{i}^{obs} + {E}_{i}^{off} \leq {E}_{i}^{th}$$

$$C 2 : n ∈ [ 1 , N ]$$

where n is the number of the selected RSU, N is the total known number of RSUs,

$${I}_{i}^{n}$$

denotes the cost incurred when vehicle i decides at the current moment, taking the smaller value between the current offloading cost

$${y}_{i}^{n}$$

and the expected offloading cost

$$E [ {I}_{i}^{n + 1} ] , where {y}_{i}^{n}$$

is the offloading cost if stopping observation and selecting the current RSU at this moment, and

$$E [ {I}_{i}^{n + 1} ]$$

is the expected cost of continuing to observe subsequent RSUs;

$${E}_{i}^{obs}$$

denotes the energy consumption required for vehicle i to observe one RSU,

$${E}_{i}^{off}$$

is the energy consumption required for vehicle i to offload the task, and

$${E}_{i}^{th}$$

is the available energy budget for vehicle i.

Preferably, the total offloading cost for vehicle i deciding to offload at its n^{th} observation moment is:

$${y}_{i}^{n} = {x}_{n} + \frac{Δ L \cdot n}{{v}_{i}} \cdot c$$

where xₙ denotes the load of server n, i.e., the total delay incurred when the task is offloaded to the selected RSU for processing; ΔL denotes the distance between adjacent RSUs, n is the number of the current RSU, vᵢ is the traveling speed of vehicle i, and c denotes the observation cost for observing one RSU.

Preferably, if vehicle i observes until the end without offloading, it must offload to the last RSU, and the optimal offloading cost at the N^{th} observation is:

$${I}_{i}^{N} = {y}_{i}^{N}$$

where

$${y}_{i}^{N}$$

offloading cost for offloading to the N^{th} RSU.

Preferably, the energy consumption required for vehicle i throughout the process is calculated as:

$${E}_{i}^{obs} = ( μ \cdot {v}_{i}^{2} + φ ) \cdot \frac{Δ L}{{v}_{i}} = ( μ \cdot {v}_{i} + \frac{φ}{{v}_{i}} ) \cdot Δ L , n \cdot {E}_{i}^{obs} + {E}_{i}^{off} \leq {E}_{i}^{th}$$

where μ denotes an energy consumption coefficient proportional to the square of the moving speed, such as an air resistance coefficient; φ denotes a fixed energy consumption coefficient independent of the vehicle's traveling speed, such as a rolling resistance coefficient; vᵢ is the traveling speed of vehicle i; ΔL denotes the distance between adjacent RSUs; n is the number of the selected RSU;

$${E}_{i}^{obs}$$

denotes the energy consumption required for vehicle i to observe one RSU,

$${E}_{i}^{off}$$

is the energy consumption required for vehicle i to offload the task, and

$${E}_{i}^{th}$$

is the available energy budget for vehicle i.

In Embodiment 2, the specific implementation processes of the functions performed by each module are the same as those in Embodiment 1 and will not be repeated here.

What is claimed is:

1. An optimal stopping task offloading optimization method in an energy-limited environment, comprising the following steps:
S1: constructing a vehicular network task offloading model based on optimal stopping theory, establishing an objective function to minimize an expected total offloading cost according to a roadside unit (RSU) load and an observation cost; introducing energy consumption constraints by constructing an energy consumption inequality;
S2: calculating a maximum allowable observation count through the energy consumption constraints, and solving based on optimal stopping theory to obtain a series of comparison thresholds;
S3: comparing an observed current RSU load with the calculated comparison thresholds to identify a locally optimal RSU that satisfies conditions for offloading.

2. The optimal stopping task offloading optimization method in the energy-limited environment according to claim 1, wherein S1: constructing the vehicular network task offloading model based on optimal stopping theory, establishing the objective function to minimize the expected total offloading cost according to the RSU load and the observation cost; introducing the energy consumption constraints by constructing the energy consumption inequality, wherein an energy consumption required for vehicle i throughout a process is calculated as:
$${E}_{i}^{obs} = ( μ \cdot {v}_{i}^{2} + φ ) \cdot \frac{Δ L}{{v}_{i}} = ( μ \cdot {v}_{i} + \frac{φ}{{v}_{i}} ) \cdot Δ L , n \cdot {E}_{i}^{obs} + {E}_{i}^{off} \leq {E}_{i}^{th}$$
wherein μ denotes an energy consumption coefficient proportional to the square of a moving speed, such as an air resistance coefficient; φ denotes a fixed energy consumption coefficient independent of a vehicle's traveling speed, such as a rolling resistance coefficient; vᵢ is a traveling speed of vehicle i; ΔL denotes a distance between adjacent RSUs; n is a number of selected RSU;
$${E}_{i}^{obs}$$
denotes an energy consumption required for vehicle i to observe one RSU,
$${E}_{i}^{off}$$
is an energy consumption required for vehicle i to offload a task, and
$${E}_{i}^{th}$$
is an available energy budget for vehicle i.

3. The optimal stopping task offloading optimization method in the energy-limited environment according to claim 2, wherein establishing the objective function to minimize the expected total offloading cost in step S1 comprises:
establishing the objective function for vehicle offloading, with an optimization problem expressed as:
$${min}_{n} E [ {I}_{i}^{n} ] = {min}_{n} E [ min \{ {y}_{i}^{n} , E [ {I}_{i}^{n + 1} ] \} ]$$
$$s . t . C 1 : n \cdot {E}_{i}^{obs} + {E}_{i}^{off} \leq {E}_{i}^{th}$$
$$C 2 : n ∈ [ 1 , n ]$$
wherein n is the number of the selected RSU, N is a total known number of RSUs,
$${I}_{i}^{n}$$
denotes a cost incurred when vehicle i decides at a current moment whether to offload the task to RSU n, taking a smaller value between a current offloading cost
$${y}_{i}^{n}$$
and an expected offloading cost
$$E [ {I}_{i}^{n + 1} ] ,$$
wherein
$${y}_{i}^{n}$$
is an onloading cost if stopping observation and selecting the current RSU at this moment, and
$$E [ {I}_{i}^{n + 1} ]$$
is an expected cost of continuing to observe subsequent RSUs;
$${E}_{i}^{obs}$$
denotes the energy consumption required for vehicle i to observe one RSU,
$${E}_{i}^{off}$$
is the energy consumption required for vehicle i to offload the task, and
$${E}_{i}^{th}$$
is the available energy budget for vehicle i.

4. The optimal stopping task offloading optimization method in the energy-limited environment according to claim 2, wherein a total offloading cost for vehicle i deciding to offload at its n^{th} observation moment is:
$${y}_{i}^{n} = {x}_{n} + \frac{Δ L \cdot n}{{v}_{i}} \cdot c$$
wherein xₙ denotes a load of RSUn, i.e., a total delay incurred when the task is offloaded to the selected RSU for processing; ΔL denotes the distance between the adjacent RSUs, n is the number of the current RSU, vᵢ is the traveling speed of vehicle i, and c denotes an observation cost for observing one RSU.

5. The optimal stopping task offloading optimization method in the energy-limited environment according to claim 1, wherein S3: comparing the observed current RSU load with the calculated comparison thresholds to identify the locally optimal RSU that satisfies the conditions for offloading; if vehicle i observes until the end without offloading, it must offload to the last RSU, and an optimal offloading cost at an N^{th} observation is:
$${I}_{i}^{N} = {y}_{i}^{N}$$
wherein
$${y}_{i}^{N}$$
is an offloading cost for offloading to the last RSU, i.e., an N^{th} RSU.

6. A system using the optimal stopping task offloading optimization method in the energy-limited environment according to claim 1, wherein the system comprises:
a model construction module, configured to construct the vehicular network task offloading model with the energy consumption constraints, establish the objective function to minimize the expected total offloading cost according to parameters such as vehicle speed, remaining energy, and RSU coverage range, and calculate an energy consumption for a single observation; the objective function parameters comprise RSU load delay, observation count, and observation cost;
a threshold calculation module, configured to calculate the maximum allowable observation count through the energy consumption constraint inequality, and solve for comparison thresholds at each observation stage using a backward induction method based on optimal stopping theory;
an offloading execution module, configured to acquire a current RSU load status and a vehicle energy status in real time, compare the current load with the corresponding stage threshold, execute task offloading when the offloading condition is satisfied, otherwise continue observation until forced offloading at the last RSU.

7. The system according to claim 6, wherein in the optimal stopping task offloading optimization method in the energy-limited environment, S1: constructing the vehicular network task offloading model based on optimal stopping theory, establishing the objective function to minimize the expected total offloading cost according to the RSU load and the observation cost; introducing the energy consumption constraints by constructing the energy consumption inequality, wherein an energy consumption required for vehicle i throughout a process is calculated as:
$${E}_{i}^{obs} = ( μ \cdot {v}_{i}^{2} + φ ) \cdot \frac{Δ L}{{v}_{i}} = ( μ \cdot {v}_{i} + \frac{φ}{{v}_{i}} ) \cdot Δ L , n \cdot {E}_{i}^{obs} + {E}_{i}^{off} \leq {E}_{i}^{th}$$
wherein μ denotes an energy consumption coefficient proportional to the square of a moving speed, such as an air resistance coefficient; φ denotes a fixed energy consumption coefficient independent of a vehicle's traveling speed, such as a rolling resistance coefficient; vᵢ is a traveling speed of vehicle i; ΔL denotes a distance between adjacent RSUs; n is a number of selected RSU;
$${E}_{i}^{obs}$$
denotes an energy consumption required for vehicle i to observe one RSU,
$${E}_{i}^{off}$$
is an energy consumption required for vehicle i to offload a task, and
$${E}_{i}^{th}$$
is an available energy budget for vehicle i.

8. The system according to claim 7, wherein in the optimal stopping task offloading optimization method in the energy-limited environment, establishing the objective function to minimize the expected total offloading cost in step S1 comprises:
establishing the objective function for vehicle offloading, with an optimization problem expressed as:
$${min}_{n} E [ {I}_{i}^{n} ] = {min}_{n} E [ min \{ {y}_{i}^{n} , E [ {I}_{i}^{n + 1} ] \} ]$$
$$s . t . C 1 : n \cdot {E}_{i}^{obs} + {E}_{i}^{off} \leq {E}_{i}^{th}$$
$$C 2 : n ∈ [ 1 , N ]$$
wherein n is the number of the selected RSU, N is a total known number of RSUs,
$${I}_{i}^{n}$$
denotes a cost incurred when vehicle i decides at a current moment whether to offload the task to RSU n, taking a smaller value between a current offloading cost
$${y}_{i}^{n}$$
and an expected offloading cost
$$E [ {I}_{i}^{n + 1} ] ,$$
wherein
$${y}_{i}^{n}$$
is an offloading cost if stopping observation and selecting the current RSU at this moment, and
$$E [ {I}_{i}^{n + 1} ]$$
is an expected cost of continuing to observe subsequent RSUs;
$${E}_{i}^{obs}$$
denotes the energy consumption required for vehicle i to observe one RSU,
$${E}_{i}^{off}$$
is the energy consumption required for vehicle i to offload the task, and
$${E}_{i}^{th}$$
is the available energy budget for vehicle i.

9. The system according to claim 7, wherein in the optimal stopping task offloading optimization method in the energy-limited environment, a total offloading cost for vehicle i deciding to offload at its n^{th} observation moment is:
$${y}_{i}^{n} = {x}_{n} + \frac{Δ L \cdot n}{{v}_{i}} \cdot c$$
wherein xₙ denotes a load of RSUn, i.e., a total delay incurred when the task is offloaded to the selected RSU for processing; ΔL denotes the distance between the adjacent RSUs, n is the number of the current RSU, vᵢ is the traveling speed of vehicle i, and c denotes an observation cost for observing one RSU.

10. The system according to claim 6, wherein in the optimal stopping task offloading optimization method in the energy-limited environment, S3: comparing the observed current RSU load with the calculated comparison thresholds to identify the locally optimal RSU that satisfies the conditions for offloading; if vehicle i observes until the end without offloading, it must offload to the last RSU, and an optimal offloading cost at an N^{th} observation is:
$${I}_{i}^{n} = {y}_{i}^{n}$$
wherein
$${y}_{i}^{n}$$
is and offloading cost for offloading to the last RSU, i.e., an N^{th} RSU.
